(19) United States
(12) Patent Application Publication
(10) Pub. No.: US 2018/0225956 A1
(43) Pub. Date: Aug. 9, 2018

(54) SMART HOME SECURITY CONTROL DEVICE

(71) Applicant: Kaipo Chen, Taoyuan City (TW)

(72) Inventor: Kaipo Chen, Taoyuan City (TW)

(21) Appl. No.: 15/942,589

(22) Filed: Apr. 2, 2018

Related U.S. Application Data
(63) Continuation-in-part of application No. 14/472,403, filed on Aug. 29, 2014.
Application No. 14/472,403 is a continuation-in-part of application No. 15/391,856, filed on Dec. 28, 2016.
Application No. 15/391,856 is a continuation-in-part of application No. 15/817,276, filed on Nov. 19, 2017.

(30) Foreign Application Priority Data
Mar. 12, 2014 (CN) 201410089724.8
Jun. 24, 2014 (CN) 201410289447.5
Dec. 18, 2015 (CN) 201510943772.3
Dec. 12, 2016 (CN) 201611142151.6
Feb. 6, 2018 (CN) 201810119176.7

(51) Int. Cl. G08B 25/01; F21V 23/04; G06F 15/18; G08B 19/00

(52) U.S. Cl. CPC G08B 25/016; G08B 19/00; G06F 15/18; F21V 23/0478

(57) ABSTRACT

A smart home security control device includes a security control device, which includes a lighting module and is provided, in the interior thereof, with a main control board and multiple modules connected with the main control board. The main control board is connected to related detection modules, which allows for expansion of different detection functions in a manner of being removable and insertable so as to make data of detection of a target body more accurate. Connection with each of electric appliances located around can be made with an infrared control module and a wireless communication module, and control can be made through an audio module that is also arranged on the main control board so that the application of the security control device for a range of smart control can be expanded.

### CROSS-REFERENCE TO RELATED APPLICATION

This is a continuation-in-part of co-pending U.S. patent application Ser. No. 14/472,403 filed on Aug. 29, 2014, Ser. No. 15/391,856 filed on Dec. 28, 2016, and Ser. No. 15/817,276 filed on Nov. 19, 2017.

### (a) TECHNICAL FIELD OF THE INVENTION

The present invention relates generally to a smart home security control device, which comprises a detection module that includes multiple detection functions arranged therein to conduct detection on a target body and a surrounding environment through function adjustment done with a removing and plugging manner and uses a main control board connected to the detection module to early out computation and drive operations of each household electrical appliance, making it better suit to need of living.

### (b) DESCRIPTION OF THE PRIOR ART

Nowadays, the light-emitting diode (LED) technology is getting mature in various applications, and in addition to the development of techniques regarding energy saving and lighting, manufacturers also focus on the development of styles and functions of LED related devices available in the market to provide multiple functions associated therewith.

However, such products are often subjected to adjustment or change of each function thereof according to various needs during the fabrication thereof. For devices that are used in public places, such as counters and lobbies of hotels, installation of a video camera for recording images or a smart device for sensing and controlling is considered acceptable; however, this often involves issues of privacy when installation is made in an enclosed private space, such as a hotel room or a bathroom.

To add or remove certain functions of such product or to expand the specification thereof in respect of the environments of application would require a significant modification of the overall structure thereof. In addition, such compound products having multiple functions involve relatively complicated designs in respect of operations and firmware maintenance thereof. In view of the above, the present invention is made to help alleviate or overcome the problems of the known products.

### SUMMARY OF THE INVENTION

The present inventor has been working in the field of research and manufacture of surveillance systems integrated with security devices and is well aware of users' needs through collection of user's experiences and feedbacks of products of this kind.

Prior art documents in this field is known. For example, US Patent Publication No. 2008/0177646 A1 discloses a work site remote monitoring and employee time tracking system, wherein image of surveillance, together with on-site biometric scanning data, is transferred through a network to a management end in order to determine the movement and behavior of the employees for the purpose of management. Such a system needs an additional device used in combination therewith and involves human labor in the use thereof. Further, Japanese Patent Applicant No. 2012-22579 discloses an LED lighting device in which a standing wave radar is included for detecting the distance and biological or physiological conditions of a human body for driving a light source and an alarm, and is applicable to buildings, transportation vehicles, and even roads. However, a major drawback is that efficient and accurate detection of abnormality of a human body is generally not available and the range of detection is generally short, so that the applicability thereof to a household or interfering environment may not be practical.

Products that are provided with application of modern technology have been developed, for at least some of them, toward artificial intelligence (AI) involved applications, such as Amazon Echo and Google Home that are currently available in the market and are both products concerning smart housekeeping. However, these products provide functionality that generally concerns integration and search of information, for building a device-interconnected application environment through connection and instruction transmission with other devices and equipment.

It is possible to establish environmental surveillance and control by using such smart devices. Firstly, novel household electrical appliances that involve built-in WIFI connection and Bluetooth operation must be provided in the household environment and additional sensors, as well as a large amount of wires, are necessarily built, not to mention additional operation of installation, connection, and definition of the sensors and settings of surveillance software, as well as issues concerning compatibility This is a project require a large amount of labor and time and is certainly not easy for general consumers.

Thus, the present invention provides a smart home security control device, which in addition to a lighting module, comprises a main control board arranged in an interior space of the device and the main control board is provided with artificial intelligence and a central processor, and a power control module that supplies electrical power. The main control board is connected to a detection module, a wireless communication module, an audio module, and an infrared control module to control household electrical appliances. The device is further provided with an information reminder panel that displays detailed data of detection of the surrounding environment and the target body, so that after detections have been conducted on the target body and the surrounding environment, an operation of activating or deactivating of related ones of the household electrical appliances can be carried out.

In addition to the lighting module, the present invention is structured such that the detection module that is connected to the main control board can made decisions concerning activation and deactivation of each individual household electrical appliance according to the statuses of the target body and the surrounding environment, wherein an image-capture module included therein, when set in connection with remote control, can be detached and separated from the device so that detection and connection with household electrical appliances that are achievable with the present invention can be made with an expanded range of distance.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of the present invention.

FIG. 2 is a block diagram of the present invention.

FIG. 3 is a schematic view illustrating connection of the present invention with an image-capture module.

FIG. 4 is a schematic view showing a second embodiment of the present invention.

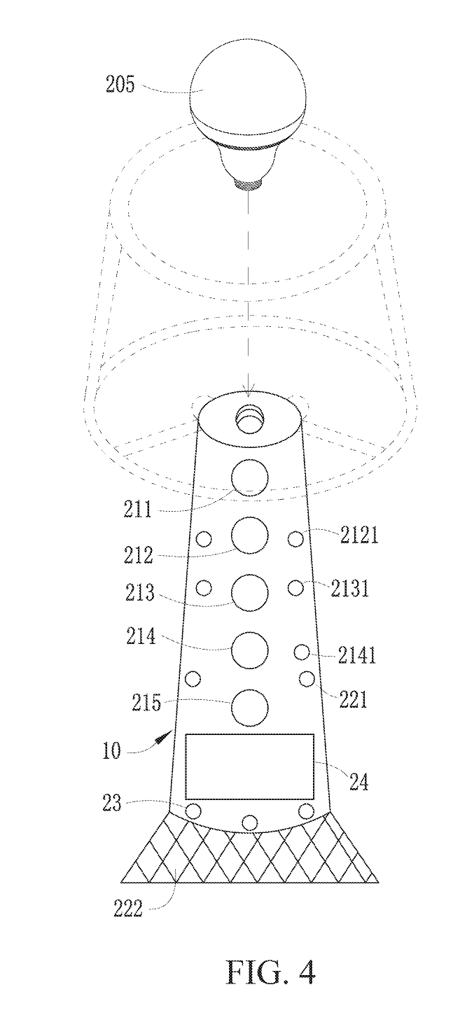

FIG. 5 is a schematic view showing a third embodiment of the present invention.

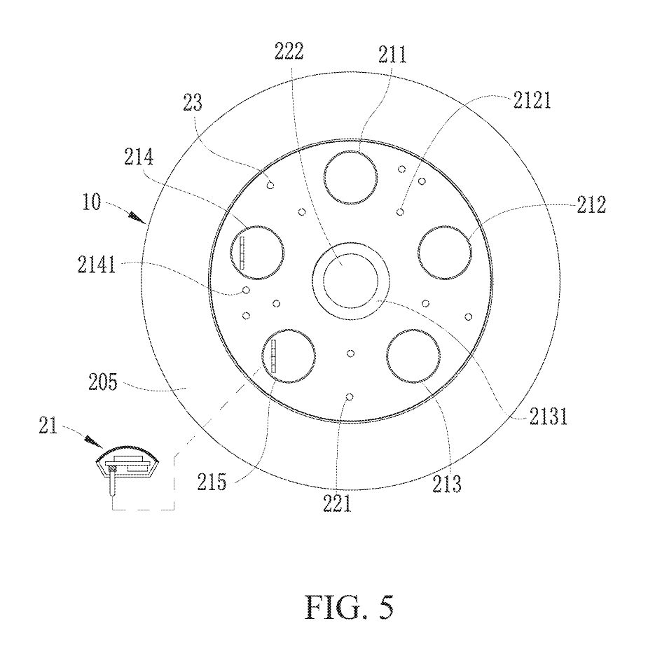

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

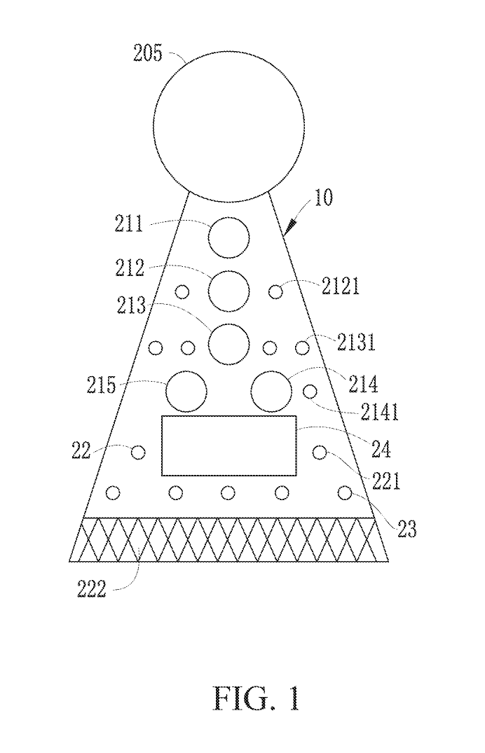

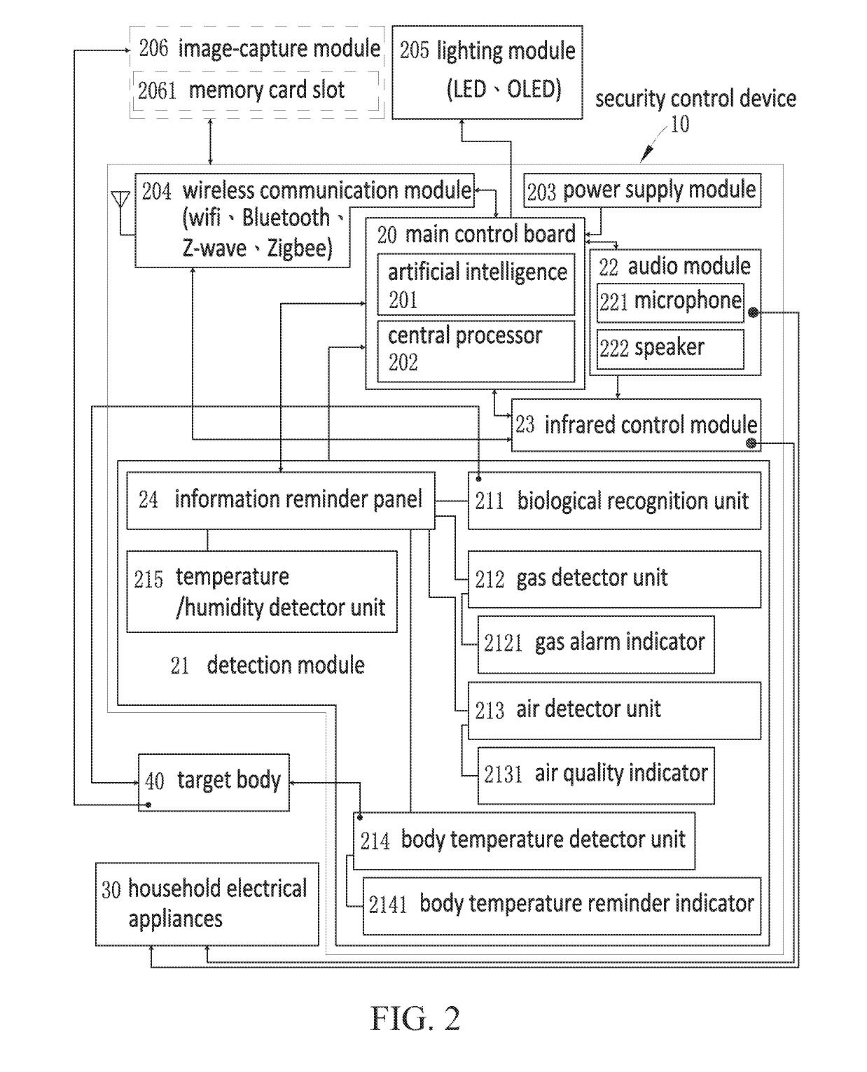

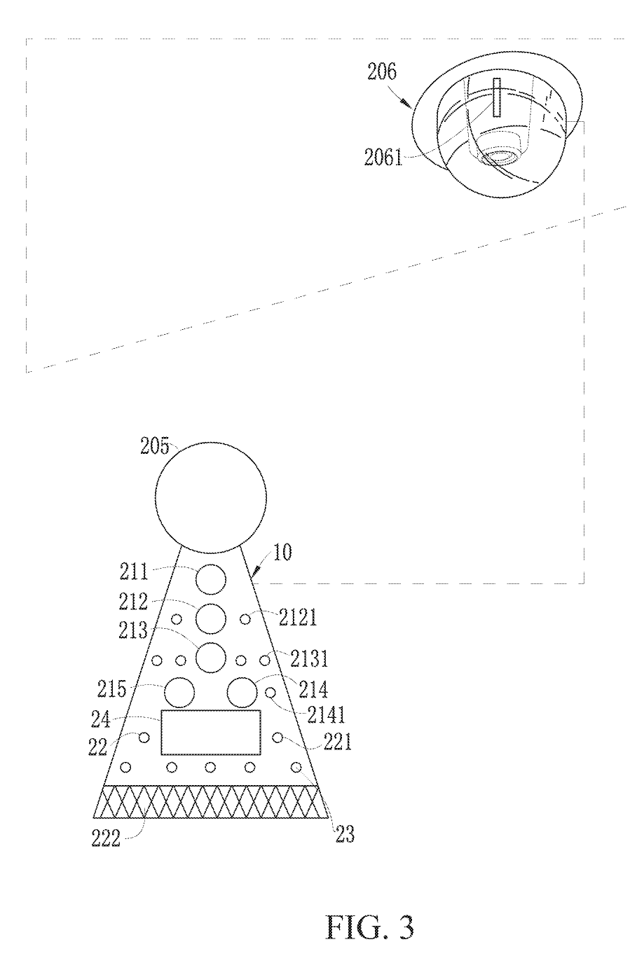

Better understanding of the present invention can be achieved according to a general detailed description of the present invention, as well as a preferred feasible embodiment thereof, in combination with the attached drawings. The present invention provides a smart home security control device, which as shown in FIGS. 1-3, is embodied as a table lamp that can be used in a public space of a hotel or in a private personal room without any abrupt feeling, and comprises a security control device (10), which comprises a main control board (20) arranged in an interior thereof. The main control board (20) is provided with artificial intelligence (201) and a central processor (202), and a power supply module (203) that supplies external electrical power for use by the security control device (10). The main control board (20) is connected to a detection module (21), a wireless communication module (204), an audio module (22), and an infrared control module (23). The security control device (10) is provided with a lighting module (205). The lighting module can be a light-emitting device (LED) or an organic light-emitting diode (OLED). The lighting module (205) is operable to receive a signal from the main control board (20). The lighting module (205) can be of single warm light, single cold light, or collective side-by-side arrangement of warm light and cold light, or a mixture unit of red, green, and blue light. The main function of the LED is lighting and no limit is imposed to the arrangement thereof.

Additionally, an information reminder panel (24) is provided on an easily viewable portion of a surface of the security control device (10). Data that are acquired by the detection module (21) through detection of the target body (40) and the surrounding environment are transmitted, through a microprocessor (210) to the main control board (20) for processing, and then fed to the information reminder panel (24) for displaying and also for carrying out an operation of activation and deactivation of the household electrical appliance (30) through the main control board (20).

The detection module (21) further comprises: a biological recognition unit (211) that conducts detections concerning position, heartbeat, and heart rate of the target body (40) and activates lighting. The target body (40) can be a user of various ages in the surrounding environment, such as a child or an elder person, or even a pet. The module is embodied as a Doppler radar that acquires data through frequency of amplitude. The biological recognition unit (211) is generally not affected by the material that makes the security control device (10) and can be hidden in the interior so that outside appearance can maintain good looking. More specifically, the target body (40) relies on the biological recognition unit (211) to conduct an operation that is based on a moving signal of a high frequency band of a breath signal so that when a breath signal is identified and, based on a moving signal, it is identified according to a resident moving within a fixed period of time that the resident is in an abnormal condition. Thus, based on standing wave analysis, detection range can be expanded and high accuracy of detecting abnormality can be achieved. Information obtained with such detection can be transmitted back to the main control board (20) to be recorded so that in case of abnormality, images and information so detected can be transmitted to a hospital to obtain remote emergent medical treatment instructions to thereby provide a certain degree of effectiveness for surveillance of the elder and young home members. During the process, temperature information of the target body (40) transmitted from a body temperature detector unit (214) to the main control board (20) may be integrated to provide assistance for determining the physiological condition.

A gas detector unit (212) detects harmful gases outside the security control device (10). The gas detector unit (212) is connected to at least one or more than one gas alarm indicator (2121). The gas alarm indicator (2121) is connected to and operable in combination with the gas detector unit (212) to detect if harmful gases (such as nitrogen monoxide, methane, propane, isobutene, natural fossil fuel vapors) are present in a detection range, and is of priority of staying activated in case of power outage and shortage of power supply. When the concentration of carbon monoxide exceeds a regular security standard level, notification will be made to a mobile phone device. When the concentration continuously increases, without any sign of reduction, then connection will be made to a network for notification of a local fire fighting department in order to avoid severe catastrophe of fire or explosion to thereby help ensure security of a household environment. During the process, the main control board (20) may further drive a speaker (222) of the audio module (22) for issuing alarms.

An air detector unit (213) detects the content of suspension particles in an environment outside the security control device (10). The air detector unit (213) is connected to at least one or more than one air quality indicator (2131), which is operable for making indication with light of different colors. The air quality indicator (2131) is operable in combination with the air detector unit (213) to detect particulate matter (PM) or suspension particles in air and to transmit related data, through the wireless communication module (24) connected to the main control board (20), to a wireless device designated, in advance, by a user, while the air quality indicator (2131) is operable to emit, in a persistent way for a long period of time, light of different colors to indicate the air quality, wherein blue indicates a normal condition, yellow indicate an intermediate condition, and red indicates the worst condition. The displayed color of light can be changed according to practical production requirement and is not to the colors discussed.

A body temperature detector unit (214) detects a body temperature of a target body (40) staying in the environment outside the security control device (10) and is connected to a body temperature reminder indicator (2141) for making reminder and notification in case the body temperature detected is outside a predetermined body temperature range. The body temperature reminder indicator (2141) is operable in combination with and in connection with the body temperature detector unit (214) for measurement of the body temperature of a family member such that a reminder or an alarm is issued when the measured data is greater than a normal temperature and to transmit notification to a handheld devices of family members when the measured body temperature of the family member is higher than a normal temperature and/or exceeds a preset threshold. After a lapse of predetermined period of time, if the body temperature of the family member is still higher than the normal temperature, then a more significant reminder through indication light is provided so that the physical condition of the family member can be effectively monitored If the target body (40) is located within an effective range of an image-capture module (206), the image-capture module (206) may be further activated to carry out videotaping or image capturing

A temperature/humidity detector unit (215) detects a temperature and humidity in the environment outside the security control device (10). The data detected by each of the previously-described units, in addition to transmission to a handheld device or an internet of vehicle, will be eventually transmitted to the information reminder panel (24) in order to provide detailed information to the target body (40). The biological recognition unit (211), the gas detector unit (212), the air detector unit (213), the body temperature detector unit (214), and the temperature/humidity detector unit (215) are each structured for addition or removal through a swappable expansion arrangement or a fixed arrangement. In a preferred embodiment of the present invention, a modularized swappable arrangement is made only for the body temperature detector unit (214) and the temperature/humidity detector unit (215) as an example for illustration. This is because the detection of body temperature and temperature/humidity are more sensitive, and in an actual application, such a modularized swappable arrangement helps effectively control the detection data in a more accurate range, allowing the operation of the security control device (10) to be kept, as a whole, in a more accurate manner.

The information reminder panel (24) provides information including: concentration of PM2.5, environment temperature and humidity, human body temperature, gas concentration, time of displaying, and other related data, or alternatively or additionally, is operable to conned by way of other handheld devices or computer devices with software to the wireless communication module (204) built in the security control device (10) to newly add other reminder items through WIFI, Bluetooth, Z-Wave, ZigBee, or other wireless communication techniques, such that the newly added reminder items can use the main control board (20) of the security control device (10) to provide sound or audio reminders through the speaker (222) built in the audio module (22), or they can use the main control board (20) to control, by way of the infrared control module (23), household electrical appliances (30) associated therewith, so that the application and connection are made flexible and easy.

The artificial intelligence (201) is operable to make decisions on the detection signals fed back from the detection module (21) and voices of the target body (40) received by the audio module (22) through a microphone (221) and to conduct analysis and conversion of related data and information for transmission to the main control board (20) in order to make connection, through the infrared control module (23) and wireless communication module (204), with related household electric appliances (30), the image-capture module (206), and the other modules for driving and operation.

The image-capture module (206) is generally driven through the wireless communication module (204) to carry out surveillance to detect, through the biological recognition unit (211) built in the security control device (10), if a target body (40) enters a predetermined range and to acquire data related to the target body (40) (such as body temperature, position, and motion) by way of other detection module (21). The image-capture module (206) is made up of multiple lens for taking an image of 360-degree full view for gaining a dead-zone-free surveillance space, or alternatively, one single lens may be used to achieve 360-degree full-view surveillance through a built-in rotation structure, or alternatively a wide-angle lens may be used. In this way, applications for room door access control in a hotel can be carried out, such that when a target body (40) enters a surveillance range of an image-capture module (206) arranged outside and above a room door, recognition of the target is carried out to determine if the target is an occupant of the room. Here, the recognition is carried out on the basis of the facial characteristics and related built in check-in so that when the occupant enters the room, activation of an air-conditioner or heater, lighting, and widow covering will be initiated, according to time and temperature. To watch television shows or listen to music, voice instructions can be given and picked up by the microphone (221) of the audio module (22). When the occupant leaves the room, all the devices connected will be automatically shut down. This would help improves the scenarios that an occupant lost the room door key and also helps reduce the potential risk of improper or incapable of operation of the electric appliances.

The way of embodying or using is not limited to what described above. The image-capture module (206) may be further connected to a memory card slot (2061), and the memory card slot (2061) is arranged at a location on an outer side of the image-capture module (206) for easy access by a user for insertion and removal purposes. The gas alarm indicator (2121), the air quality indicator (2131), and the body temperature reminder indicator (2141), in addition to reminder alarms provided in the form of light of different colors or different flashing frequencies, may be connected, through the main control board (20), the audio module (22) to provide audio sounds or voices for the purposes of strengthening reminder or alarm. The audio module (22), as mentioned above, is provided with a the microphone (221) for picking up external voices and sounds and a speaker (222) for output of sound effects, such that oral instruction given by a target body (40) can be made to the main control board (20) to have the audio module (22) recognize and convert the sounds into instructions, which is then fed, through connection of the audio module (22) with the infrared control module (23), as a signal transmitted therethrough, to allow the security control device (10) to establish connection with the electrical appliance (30) to conduct a corresponding operation. The microphone (221) and the speaker (222) may each be installed in multiplicity of which the number is sufficient to achieve a desired level of accuracy of sound pickup. Voices received in the audio module (22) are converted into signals for the infrared control module (23) and the infrared control module (23) is operable to connect with the detection module (21) through transmission and receipt of infrared light, voices, or wireless control, for automatically controlling common electrical appliances, such as air-conditioner/heater, air purifier, dehumidifier, television, and light. The infrared control module (23) may be connected with the wireless communication module (204) for conversion of a wireless signal into an infrared signal or conversion of an infrared signal into a wireless signal, so that an electrical appliance (30) that lacks a function of one of wireless signal or infrared light can also be driven for operation, or alternatively, a receiver that receives signal and controls can be additionally included and installed so that the purposes of control can be achieved through addition code pairing operations and in this way, small electrical appliances, such as electric fan, and coffee maker, that do not have built-in transmission technology for wireless signals or Bluetooth can be properly controlled. Thus, light and other electrical appliances can be automatically turned on when a user enters a detection range; and when the user leaves, the light and the electrical appliances so connected are automatically shut down. The activation of the electrical appliance is primarily based on and controlled by the main control board (20); however after the electrical appliance (30) is activated, if the target body (40) gives oral instruction to the audio module (22) to control the electrical appliance (30), then the oral instruction may take priority over the main control board (20) to ease the operation of being controlled by the user.

A second embodiment of the present invention is a security control device (10) that is configured as a table lamp and comprises components that are the same as those described in the previous embodiment, but with the difference that the air quality indicator (2131) is simplified. Repeated description of the operation mode, which is the same as the previous embodiment, will be omitted. In this embodiment, the lighting module (205) may also be removed, if desired, so that the security control device (10) of the second embodiment can be embodied in such a way that lighting is externally mounted.

A third embodiment of the present invention provides a ceiling light that comprises components that are the same as those described in the previous embodiments, but a difference is that the body temperature detector unit (214) and the temperature/humidity detector unit (215) are made in a structure of being removable and expandable in a swappable manner, while the other detection units are made in the form of fixed devices. And, in addition, the air quality indicator (2131) is structured such that indicators of multiple colors of light is confined at the same site for easy displaying of different colors to be read by a user. The speaker (222) is set at a location that is at a center of the air quality indicator (2131), while multiple microphones (221) are arranged to distribute on the ceiling light in order to improve accuracy of voice pick up for audio control. Repeated description of the other operations, which are generally the same as the previous embodiments, will be omitted.

In summary, the smart home security control device of the present invention is provided with a main control board (20) arranged therein to allow artificial intelligence (201) and a central processor (202) to read and make decisions on data fed back from a detection module (21) so that the main control board (20) and an audio module (22) may carry out signal transmission through an infrared control module (23) or a wireless communication module (204) to drive each individual electrical appliance (30), allowing for expanded applications of detection range of a target body (40).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A smart home security control device, which is operable to drive electrical appliances through detection made on target bodies, comprising: a security control device, which is provided therein with a main control board comprising artificial intelligence and a central processor, and a power supply module that supplies external electrical power for use by the security control device, the main control board being connected to a detection module, a wireless communication module, an audio module, and an infrared control module, the security control device being provided with a lighting module.

2. The smart home security control device according to claim 1 further comprising: an information reminder panel, which is provided on an easily viewable portion of a surface of the security control device such that data that are acquired by the detection module through the detection of the target body and a surrounding environment are transmitted, through the main control board to the information reminder panel for displaying and also for carrying out an operation of activation and deactivation of the household electrical appliance through the main control board.

3. The smart home security control device according to claim 2 further comprising: a biological recognition unit that detects position, heartbeat, and heart rate of a target body; a gas detector unit that detects a harmful gas outside the security control device, the gas detector unit being connected to at least one or more than one gas alarm indicator; an air detector unit that detects content of a particulate matter in an environment outside the security control device, the air detector unit being connected to at least one or more than one air quality indicator, which is operable for making indication with light of different colors; a body temperature detector unit that detects a body temperature of the target body in an environment outside the security control device and connected to a body temperature reminder indicator that makes reminder for a detection result that is outside a predetermined body temperature range; and a temperature/humidity detector unit that detects a temperature and a humidity level of an environment outside the security control device, these units being connected to a microprocessor provided in the security control device for subsequent transmission to the main control board for further transmission to the information reminder panel to provide detailed data.

4. The smart home security control device according to claim 3, wherein each of the units provided in the detection module is selectively removable or addable according to a client's requirement.

5. The smart home security control device according to claim 3, wherein the gas detector unit, the air detector unit, the body temperature detector unit, and the temperature/humidity detector unit are of a swappable arrangement for selective connection with the main control board for the purposes of adjustment of detection.

6. The smart home security control device according to claim 1, wherein the audio module further comprises: a microphone that is operable to receive voice for recognition and sound input in a predetermined range; and a speaker for output of sounds, the audio module being connectable with the infrared control module for transmitting an infrared signal to activate and deactivate the electric appliances.

7. The smart home security control device according to claim 1, wherein the audio module is connectable with the wireless communication module for transmission a wireless signal to activate and deactivate the electric appliances.

8. The smart home security control device according to claim 1, wherein the infrared control module is connectable with the wireless communication module for conversion of a wireless signal for driving the infrared control module to activate and deactivate the electric appliances.

9. A smart home security control device, which is operable to drive electrical appliances through detection made on target bodies, comprising: a security control device, which is provided therein with a main control board comprising artificial intelligence and a central processor, and a power supply module that supplies external electrical power for use by the security control device, the main control board being connected to a detection module, a wireless communication module, an audio module, and an infrared control module, the security control device being provided with a lighting module; an information reminder panel, which is provided on an easily viewable portion of a surface of the security control device such that data that are acquired by the detection module through the detection of the target body and a surrounding environment are transmitted, through the main control board to the information reminder panel for displaying and also for carrying out an operation of activation and deactivation of the household electrical appliance through the main control board; and an image-capture module that is arranged as being independent of the security control device, the image-capture module having a wireless transmission function and a memory card slot and being operable for signal connection and transmission with the wireless communication module inside the security control device in order to carry out image capture and recognition for a target body being detected in the predetermined range.
